(19) United States
(12) Patent Application Publication
(10) Pub. No.: US 2025/0229346 A1
(43) Pub. Date: Jul. 17, 2025

(54) TOOL BODY AND ROTARY CUTTING TOOL

(71) Applicant: TUNGALOY CORPORATION, Fukushima (JP)

(72) Inventors: Takahiro ASO, Iwaki-shi (JP); Ryuichi SAJI, Iwaki-shi (JP)

(73) Assignee: TUNGALOY CORPORATION, Fukushima (JP)

(21) Appl. No.: 18/981,437

(22) Filed: Dec. 13, 2024

(30) Foreign Application Priority Data
Jan. 15, 2024 (JP) 2024-003893

(51) Int. Cl. B23C 5/08

(52) U.S. Cl. CPC B23C 5/08

(57) ABSTRACT

The present invention provides a tool body that is rotated around a central axis, with a central part thereof being assembled onto an arbor, in which the tool body includes a plurality of recessed parts provided circumferentially between the central part and an outer peripheral part, as viewed from the front side opposite to an assembly side with respect to the arbor, and the recessed parts are each formed so as to have a cross-sectional shape that is gradually narrowed in a depth direction.

### BACKGROUND

### Field

The present invention relates to a tool body and a rotary cutting tool.

### Description of Related Art

Patent Document 1 (JPH04-331012 A) discloses a technique for reducing the weight of a rotary cutting tool, such as a milling cutter, by forming a plurality of through holes. Patent Document 2 (JP2006-015444 A) discloses a face milling cutter having a tool body that includes a plurality of recesses and further includes recessed pockets formed in a peripheral part at a leading end.

In a rotary cutting tool provided with a plurality of through holes, as in the technique disclosed in Patent Document 1, sufficient weight reduction cannot be achieved and the overall stiffness is reduced.

On the other hand, in the technique disclosed in Patent Document 2, providing a plurality of recesses and further providing the recessed pockets in the peripheral part at the leading end enables a sufficient weight reduction to be achieved while also securing the overall stiffness. However, such configuration reduces the strength of the peripheral part where cutting edges are provided and limits the number of cutting edges provided on the peripheral part.

### SUMMARY

The present invention has been made in light of the above circumstances, and an object of the present invention is to provide a tool body and a rotary cutting tool that can be provided with an increased number of cutting edges, while maintaining a high level of stiffness.

A tool body according to an aspect of the present invention is a tool body that is rotated around a central axis, with a central part thereof being assembled onto an arbor, the tool body including: a plurality of recessed parts provided circumferentially between the central part and an outer peripheral part, as viewed from a front side opposite to an assembly side with respect to the arbor, in which the recessed parts are each formed so as to have a cross-sectional shape that is gradually narrowed in a depth direction.

In the tool body having the configuration described above, the plurality of recessed parts are provided circumferentially between the central part and the outer peripheral part as viewed from the front side. Furthermore, the recessed parts are each formed so as to have a cross-sectional shape which is gradually narrowed in the depth direction. Such configuration makes it possible to achieve a weight reduction while suppressing the reduction of stiffness caused by the provision of the recessed parts. In addition, since the plurality of recessed parts are provided between the central part and the outer peripheral part, it is possible to suppress a reduction in the stiffness of the outer peripheral part on which the cutting edges are provided and a reduction in the number of cutting edges that can be provided on the outer peripheral part, in comparison with a structure in which lightening holes are formed in the outer peripheral part.

A bottom part of each recessed part, a front side-end of the central part, and a front side-end of the outer peripheral part may be arranged, in such order, in an axial direction from the assembly side with respect to the arbor.

The recessed parts may each have an outer circumferential-side inclined surface that is inclined so as to gradually approach the front side as it extends outward in a radial direction.

The recessed parts may each have an inner circumferential-side inclined surface on the central part side with respect to the outer circumferential-side inclined surface, the inner circumferential-side inclined surface being inclined so as to gradually approach the assembly side as it extends outward in the radial direction, and an inclination angle formed by the outer circumferential-side inclined surface with respect to a plane that is perpendicular to the central axis may be formed so as to be larger than that of the inner circumferential-side inclined surface.

In a cross-section taken along a virtual line connecting the deepest point in a bottom part of the recessed part as viewed from the front side to the central axis, the inclination angle of the outer circumferential-side inclined surface may be formed so as to be larger than an inclination angle of the inner circumferential-side inclined surface.

In a cross-sectional view, the recessed parts may each have a V-shaped portion.

The V-shaped portion in the recessed part may have a front inclined surface located on a front side in a rotating direction and a rear inclined surface located on a rear side in the rotating direction, and an inclination angle formed by the front inclined surface with respect to a plane that is perpendicular to the central axis may be formed so as to be larger than that of the rear inclined surface.

As viewed from the front side, the recessed parts may each have a tapered part that is gradually tapered toward the outer peripheral part.

A rotary cutting tool according to another aspect of the present invention includes the above-described tool body and a cutting edge provided on the outer peripheral part of the tool body.

### BRIEF DESCRIPTION OF DRAWINGS

FIG. 1 is a perspective view showing a rotary cutting tool that includes a tool body according to an embodiment of the present invention, as well as an arbor and a fastening component.

FIG. 2 is a perspective view of the rotary cutting tool.

FIG. 3 is a front view of the rotary cutting tool.

FIG. 4 is a side view of the rotary cutting tool.

FIG. 5 is a cross-sectional view taken along line V-V in FIG. 3.

FIG. 6 is a cross-sectional view taken along line VI-VI in FIG. 3.

### DETAILED DESCRIPTION

Now, an embodiment of the present invention will be described in detail below with reference to the attached drawings.

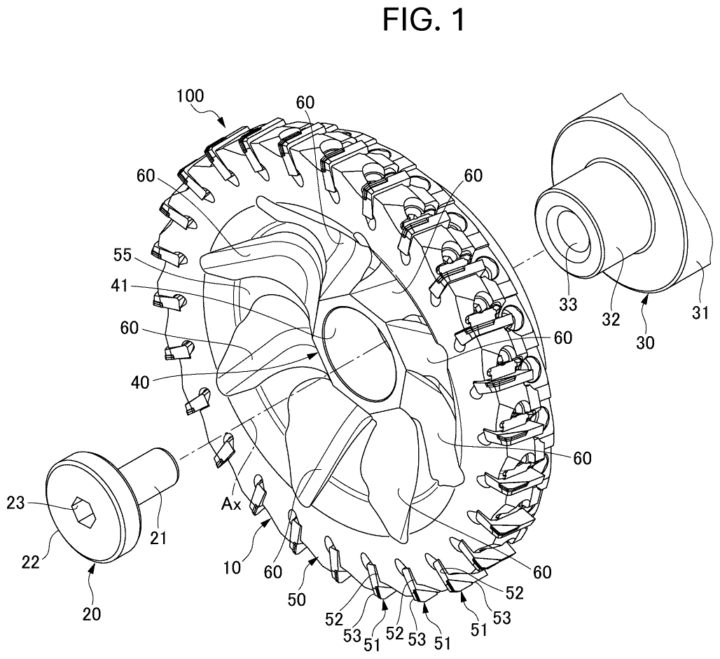

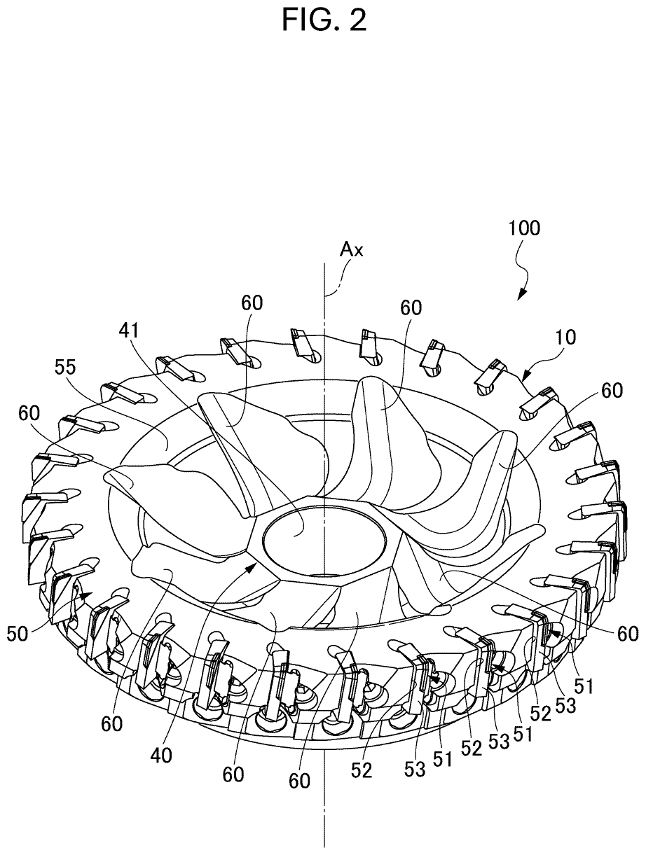

As shown in FIGS. 1-3, a tool body 10 according to the present embodiment is formed in a disc shape. The tool body 10 may be a body of a rotary cutting tool 100, such as a face milling cutter, which is used for the purpose of performing a cutting process on a workpiece. The tool body 10 is fixed and assembled onto an arbor 30 by using a fastening component 20.

The arbor 30 is mounted on a machine tool such as, for example, a machining center, and includes a boss part 31. The boss part 31 is provided with a cylindrical mounting shaft 32 having a hole 33 whose inner peripheral surface is provided with a female thread.

The fastening component 20 is a fixture bolt for fixing the tool body 10 onto the arbor 30, and the fastening component 20 is fastened onto the mounting shaft 32 formed on the boss part 31 of the arbor 30. The fastening component 20 has a shaft part 21 and a head part 22. The shaft part 21 has an outer peripheral surface which is provided with a male thread. The head part 22 is formed in a disc shape having a larger diameter than that of the shaft part 21. The head part 22 is provided with an engagement hole 23 at a central part thereof. The engagement hole 23 may be a tool hole such as, for example, a hexagon socket or a Torx socket, into which a tool such as a wrench can be inserted.

The tool body 10 has a front surface 10a and a rear surface 10b, and the tool body 10 is assembled with the arbor 30 with the rear surface 10b side facing the arbor 30. In the tool body 10, a portion between a central part 40 and an outer peripheral part 50 in a front view is circumferentially recessed in an annular form, and such recessed portion serves as an annular recessed part 55.

The tool body 10 has a mounting hole 41 in the central part 40 thereof. The mounting shaft 32 provided on the boss part 31 of the arbor 30 is inserted into such mounting hole 41. The shaft part 21 of the fastening component 20 is screwed into and thereby fastened with the hole part 33 in the mounting shaft 32 which has been inserted in such mounting hole 41. As a result, the tool body 10 is assembled with the central part 40 thereof fixed onto the arbor 30 by the fastening component 20. It should be noted that the tool body 10 and the mounting shaft 32 of the boss part 31 are provided with a key and a keyway (each not shown), respectively, that engage with each other, in order to transmit rotary force of the arbor 30 to the tool body 10.

The tool body 10 is provided with a plurality of cutting edges 51 on the outer peripheral part 50 on the front surface 10a side. A plurality of insert seats 52 are provided on the outer peripheral part 50 of the tool body 10. These insert seats 52 are circumferentially arranged with spacing therebetween, and cutting inserts 53 are mounted on the respective insert seats 52. By mounting the cutting inserts 53 on these insert seats 52, a rotary cutting tool 100 provided with the plurality of cutting edges 51 on the outer peripheral part 50 of the tool body 10 can be obtained. The rotary cutting tool 100 may be configured such that the cutting edges 51 are directly provided on the outer peripheral part 50 of the tool body 10.

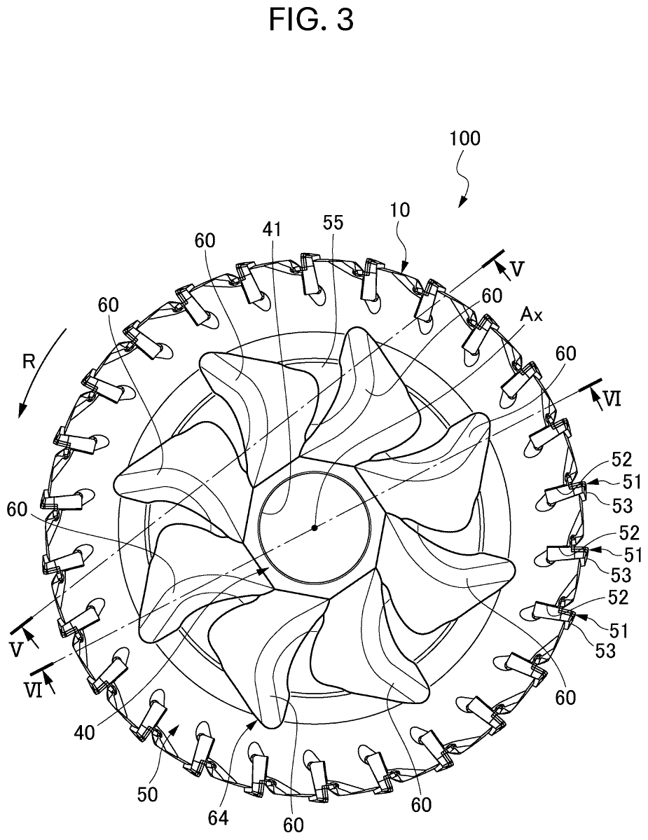

In this way, the rotary cutting tool 100 is assembled with the arbor 30, with the rear surface 10b of the tool body 10 facing the arbor 30, and the rear surface 10b side serves as an assembly side with respect to the arbor 30. By rotating the rotary cutting tool 100 along with the arbor 30 in a rotating direction R around the central axis Ax (see FIG. 3), the rotary cutting tool 100 performs a cutting process with respect to a workpiece with the cutting edges 51 provided on the front surface 10a side in the outer peripheral part 50 of the tool body 10.

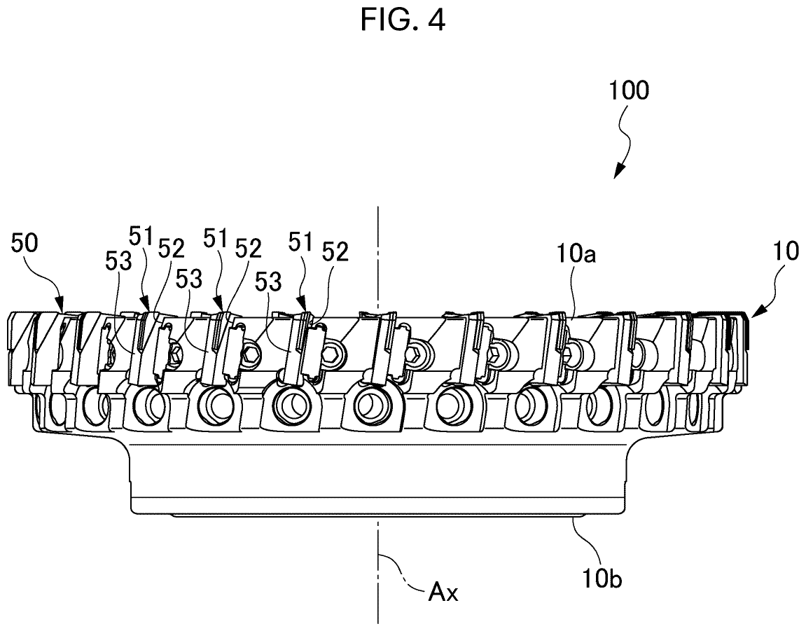

As shown in FIGS. 4-6, the tool body 10 has a plurality of recessed parts 60 in a front view. These recessed parts 60 are provided circumferentially between the central part 40 and the outer peripheral part 50 of the tool body 10. The recessed parts 60 are each shaped so as to be furtherer recessed from a bottom part of the annular recessed part 55 between the central part 40 and the outer peripheral part 50. The weight of the tool body 10 is reduced by providing the plurality of recessed parts 60 between the central part 40 and the outer peripheral part 50 thereof. It should be noted that, although parts of circumferentially adjacent recessed parts 60 communicate with each other on the central part 40 side thereof, such circumferentially adjacent recessed parts 60 may alternatively be provided with spacing therebetween.

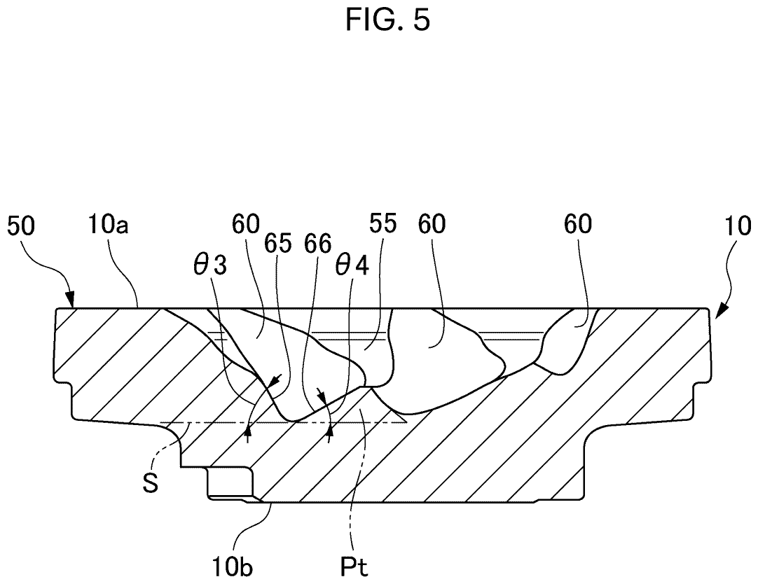

FIG. 5 shows a cross-section taken along a virtual line perpendicular to the extending direction of a recessed part 60 on the central part 40 side in the tool body 10 (cross-section taken along line V-V in FIG. 3). As shown in FIG. 5, the recessed parts 60 formed in the tool body 10 each have a cross-sectional shape which is gradually narrowed in the depth direction.

Here, the recessed parts formed in the tool body 10 do not necessarily have to have a cross-sectional shape which is gradually narrowed in the depth direction in order to achieve the weight reduction of the tool body 10. More specifically, a volume reduction resulting from the formation of recessed parts contributes to the weight reduction of the tool body 10. Thus, even if the recessed parts each have a rectangular cross-sectional shape which has a constant width in the depth direction, it is possible to achieve the same level of weight reduction as long as the same amount of volume is reduced. In the case where the recessed parts that each have a rectangular cross-sectional shape are formed, portions that each have a rectangular cross-sectional shape having the same width along the axial direction of the tool body 10 are formed between the recessed parts.

On the other hand, by forming the recessed parts 60 each having a cross-sectional shape which is gradually narrowed in the depth direction as in the present embodiment, a portion Pt having a triangular cross-sectional shape is formed between the recessed parts 60 in the tool body 10 (see FIG. 5). The portion Pt having such triangular cross-sectional shape has a root portion that is wider than that of the portion having a rectangular cross-sectional shape that would be formed when a rectangular recessed part having a constant width in the depth direction is provided, even if the reduced volume resulting from the formation of the recessed parts in both cases is the same, and this enables a high strength to be maintained. Therefore, according to the tool body 10 provided with the recessed parts 60 each having a cross-sectional shape which is gradually narrowed in the depth direction in the present embodiment, it is possible to achieve weight reduction of the tool body 10, while suppressing a reduction in the stiffness of the tool body 10 and securing a high strength against flexure.

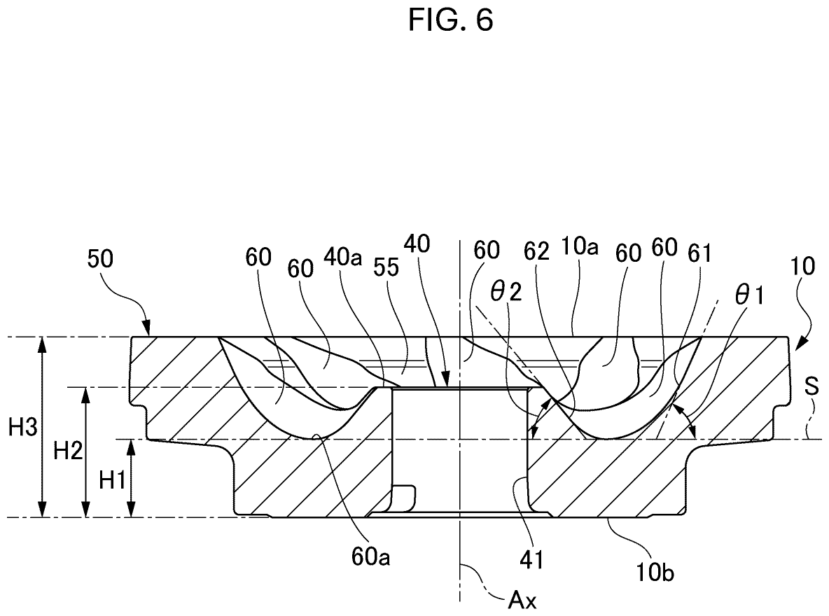

FIG. 6 shows a cross-section taken along a virtual line connecting the deepest point in the bottom part 60a of a recessed part 60 and the central axis Ax (cross-section taken along line VI-VI in FIG. 3). The deepest point in the bottom part 60a of the recessed part 60 refers to a point which is closest to the rear surface 10b in the recessed part 60 and also includes an area around such point. In the cross-sectional view of FIG. 6, the tool body 10 is configured such that: the rear surface 10b located on the assembly side with respect to the arbor 30; the bottom part 60a of the recessed part 60; a front surface 10a-side end surface of the central part 40 having a contact part 40a with which the fastening component 20 makes contact; and a front surface 10a-side end surface of the outer peripheral part 50 on which the cutting edges 51 are provided, are arranged in such order in the axial direction. In other words, in the tool body 10, a dimension H1 from the rear surface 10b of the tool body 10 to the bottom part 60a of the recessed part 60, a dimension H2 from the rear surface 10b of the tool body 10 to the front surface 10a-side end surface of the central part 40, and a dimension H3 from the rear surface 10b of the tool body 10 to the front surface 10a-side end surface of the outer peripheral part 50, satisfies a relationship of H1<H2<H3.

Such dimensions allow the tool body 10 to secure a sufficient thickness of the outer peripheral part 50, which receives a large force during a cutting process and is therefore required to have the highest stiffness, and to thereby maintain a high strength. In addition, the tool body 10 can also secure a sufficient thickness of the central part 40 which is assembled onto the arbor 30 by the fastening component 20 and is therefore required to have a high stiffness, and can thereby maintain a high strength. Thus, the weight reduction of the tool body 10 can be achieved by providing the recessed parts 60, while maintaining a high strength of the outer peripheral part 50 and the central part 40.

As shown in FIG. 6, the recessed part 60 has an outer circumferential-side inclined surface 61 which is inclined so as to gradually approach the front surface 10a of the tool body 10 as it extends outward in the radial direction. The recessed part 60 also has an inner circumferential-side inclined surface 62 on the central part 40 side with respect to the outer circumferential-side inclined surface 61, and such inner circumferential-side inclined surface 62 is inclined so as to gradually approach the rear surface 10b of the tool body 10 as it extends outward in the radial direction. An inclination angle θ1 formed by the outer circumferential-side inclined surface 61 with respect to a plane S that is perpendicular to the central axis Ax is formed so as to be larger than an inclination angle θ2 formed by the inner circumferential-side inclined surface 62 with respect to the plane S that is perpendicular to the central axis Ax.

Here, when the rotary cutting tool 100 is used to cut a workpiece, a fluid, such as a coolant, that is supplied through the arbor 30 may be discharged radially outward from the central part 40 side in the tool body 10 toward a portion that is being cut by the cutting edges 51. In such case, the tool body 10 that includes the recessed parts 60 each having the outer circumferential-side inclined surface 61 can smoothly guide the fluid discharged from the central part 40 side, along the outer circumferential-side inclined surface 61 of the recessed part 60, toward the outer peripheral part 50 on which the cutting edges 51 are provided. With such configuration, it is possible to smoothly supply the fluid to the cutting edges 51 on the outer peripheral part 50, and thereby cool and lubricate such cutting edges 51.

In particular, the recessed parts 60 each have the inner circumferential-side inclined surface 62 on the central part 40 side with respect to the outer circumferential-side inclined surface 61, and such inner circumferential-side inclined surface 62 is inclined so as to gradually approach the rear surface 10b of the tool body 10 as it extends outward in the radial direction. In this way, by configuring a portion on the central part 40 side with respect to the outer circumferential-side inclined surface 61 so as to be inclined toward the rear surface 10b side, it becomes possible to smoothly guide the fluid discharged radially outwardly from the central part 40 side in the tool body 10 toward the outer circumferential-side inclined surface 61, without obstructing the injection of such fluid. The fluid guided toward the outer circumferential-side inclined surface 61 is then guided, along the outer circumferential-side inclined surface 61 having the inclination angle θ1 that is larger than the inclination angle θ2 of the inner circumferential-side inclined surface 62, toward the outer peripheral part 50 of the tool body 10 on which the cutting edges 51 are provided. With such configuration, it is possible to smoothly supply the fluid to the cutting edges 51 on the outer peripheral part 50, and thereby cool and lubricate such cutting edges 51. The larger the inclination angle θ1 of the outer circumferential-side inclined surface 61 that directly guides the fluid to the cutting edges 51 is, the more preferable it is for the outer circumferential-side inclined surface 61 to divert the fluid so as to be guided toward the cutting edges 51. Therefore, the inclination angle θ1 of the outer circumferential-side inclined surface 61 is configured so as to be larger than the inclination angle θ2 of the inner circumferential-side inclined surface 62 that is provided in order not to obstruct the injection of the fluid.

As shown in FIG. 5, forming the recessed part 60 so as to have a V-shaped portion on the central part 40 side in the tool body 10 makes it possible to even more smoothly guide the fluid which is discharged radially outward from the central part 40 side toward the outer peripheral part 50 on which the cutting edges 51 are provided, and to further enhance the discharging efficiency for chips that are generated during a cutting process using the cutting edges 51 on the outer peripheral part 50.

Here, the recessed part 60 which has a V-shaped portion on the central part 40 side in the tool body 10 has a front inclined surface 65 located on the front side in the rotating direction R and a rear inclined surface 66 located on the rear side in the rotating direction R. An inclination angle θ3 formed by the front inclined surface 65 with respect to the plane S that is perpendicular to the central axis Ax is formed so as to be larger than an inclination angle θ4 formed by the rear inclined surface 66 with respect to the plane S that is perpendicular to the central axis Ax. Configuring the recessed part 60 so as to have the V-shaped portion with such front inclined surface 65 and rear inclined surface 66 makes it possible to even more smoothly guide the fluid toward the cutting edges 51 on the outer peripheral part 50 and further enhance the discharging efficiency for chips that are generated during a cutting process.

As shown in FIG. 3, in a front view of the tool body 10, the recessed part 60 has a tapered part 64 that is gradually tapered toward the outer peripheral part 50 of the tool body 10. Providing the recessed part 60 with such tapered part 64 makes it possible to increase, at the tapered part 64, the flow rate of the fluid that has been discharged radially outwardly from the central part 40 side in the tool body 10 and entered the recessed part 60. In addition, providing the recessed part 60 with the tapered part 64 makes it possible to maintain the thickness of the outer peripheral part 50. Such configuration makes it possible to secure the thickness, and thereby maintain the stiffness, of portions between the recessed parts 60 on the outer peripheral part 50 side, while more preferably guiding the fluid toward the outer peripheral part 50 of the tool body 10 on which the cutting edges 51 are provided.

As described above, according to the tool body 10 according to the present embodiment, as well as the rotary cutting tool 100 comprising such tool body 10, the plurality of recessed parts 60 are provided circumferentially between the central part 40 and the outer peripheral part 50 in a front view. In addition, the recessed parts 60 are each formed so as to have a cross-sectional shape which is gradually narrowed in the depth direction. Such configuration makes it possible to reduce the weight of the tool body 10, while suppressing the reduction of stiffness of the tool body 10 caused by the provision of the recessed parts 60. Furthermore, since the plurality of recessed parts 60 are provided between the central part 40 and the outer peripheral part 50 of the tool body 10, it is possible to suppress a reduction in the stiffness of the outer peripheral part 50 on which the cutting edges 51 are provided and a reduction in the number of cutting edges 51 that can be provided on the outer peripheral part 50, in comparison with a structure in which lightening holes are formed in the outer peripheral part 50.

The present invention provides a tool body and a rotary cutting tool that can be provided with an increased number of cutting edges, while maintaining a high level of stiffness.

What is claimed is:

1. A tool body that is rotated around a central axis, with a central part thereof being assembled onto an arbor, the tool body comprising:
a plurality of recessed parts provided circumferentially between the central part and an outer peripheral part, as viewed from a front side opposite to an assembly side with respect to the arbor,
wherein the recessed parts are each formed so as to have a cross-sectional shape that is gradually narrowed in a depth direction.

2. The tool body according to claim 1, wherein a bottom part of each recessed part, a front side-end of the central part, and a front side-end of the outer peripheral part are arranged, in such order, in an axial direction from the assembly side with respect to the arbor.

3. The tool body according to claim 1, wherein the recessed parts each have an outer circumferential-side inclined surface that is inclined so as to gradually approach the front side as it extends outward in a radial direction.

4. The tool body according to claim 3, wherein the recessed parts each have an inner circumferential-side inclined surface on a side of the central part with respect to the outer circumferential-side inclined surface, the inner circumferential-side inclined surface being inclined so as to gradually approach the assembly side as it extends outward in the radial direction,
wherein an inclination angle formed by the outer circumferential-side inclined surface with respect to a plane that is perpendicular to the central axis is formed so as to be larger than that of the inner circumferential-side inclined surface.

5. The tool body according to claim 4, wherein, in a cross-section taken along a virtual line connecting a deepest point in a bottom part of the recessed part as viewed from the front side to the central axis, the inclination angle of the outer circumferential-side inclined surface is formed so as to be larger than an inclination angle of the inner circumferential-side inclined surface.

6. The tool body according to claim 1, wherein, in a cross-sectional view, the recessed parts each have a V-shaped portion.

7. The tool body according to claim 6, wherein the V-shaped portion in the recessed part has a front inclined surface located on a front side in a rotating direction and a rear inclined surface located on a rear side in the rotating direction,
wherein an inclination angle formed by the front inclined surface with respect to a plane that is perpendicular to the central axis is formed so as to be larger than that of the rear inclined surface.

8. The tool body according to claim 1, wherein, as viewed from the front side, the recessed parts each have a tapered part that is gradually tapered toward the outer peripheral part.

9. A rotary cutting tool, comprising:
the tool body according to claim 1, and
a cutting edge provided on the outer peripheral part of the tool body.
